(19) United States
(12) Patent Application Publication
(10) Pub. No.: US 2020/0207006 A1
(43) Pub. Date: Jul. 2, 2020

(54) METHOD OF MANUFACTURING A THERMOFORMING CONVEX MOLD

(71) Applicants: INTERFACE TECHNOLOGY (CHENGDU) CO., LTD., Chengdu City (CN); INTERFACE OPTOELECTRONICS (SHENZHEN) CO., LTD., Shenzhen City (CN); GENERAL INTERFACE SOLUTION LIMITED, Miaoli County (TW)

(72) Inventors: YE TING TSAU, SHENZHEN CITY (CN); SHENG CHE CHEN, SHENZHEN CITY (CN)

(21) Appl. No.: 16/244,256

(22) Filed: Jan. 10, 2019

(30) Foreign Application Priority Data
Dec. 26, 2018 (CN) 201811600944.7

(51) Int. Cl. B29C 51/30; B29C 51/00

(52) U.S. Cl. CPC B29C 51/30; B29K 2067/003; B29C 51/002

(57) ABSTRACT

In a method of manufacturing a thermoforming convex mold, the specification of a convex fixture is determined according to the curve shape of a thermoformed film sensor. The curve shape has a plane portion and a curve portion vertically downwardly extended from edges of the plane portion. The convex fixture has a base and a convex structure thereon. The height of each of the convex structure and the curve portion is in a range of 1 mm to 5 mm. The curvature radius of the curve corner between the top and the side wall of the convex structure is lower than 2 mm and higher than 0 mm. Next, the position of the side wall of the convex structure is uniformly shrunk inwardly by 0.4 mm to 0.6 mm, and the height of the convex structure is increased by 200% to 250%.

This application claims priority for China patent application no. 201811600944.7 filed on Dec. 26, 2018, the content of which is incorporated by reference in its entirety.

### BACKGROUND OF THE INVENTION

### 1. Field of the Invention

The present invention relates to a method of manufacturing a convex mold, and more particular to a method of manufacturing a thermoforming convex mold.

### 2. Description of the Related Art

In recent years, smart devices such as smart phones, smart watches, and smart medical devices are equipped with large screens for users to view information. These smart devices with powerful functions trends towards personalization and fashion for appearance, shape, color and so on. These improvements can be achieved by an impressive shell design and related manufacturing technique.

At present, the curved shell shape is particularly attractive, and it gradually becomes the future trend of smart devices. The shape of thermoforming fixtures can be designed according to requirements. However, after the transparent substrate of a thin film sensor is thermoformed and bent, the transparent substrate has sprung back due to residual stress, and it causes failure of the thin film sensor fittingly attached with a three-dimensional curved cover glass, so that it is not easy to evaluate the quality of the thermoformed film sensor.

### SUMMARY OF THE INVENTION

The primary objective of the present invention is to provide a method of manufacturing a thermoforming convex mold. In the method, the side walls of a convex structure are inwardly shrunk uniformly by 0.4 mm to 0.6 mm, and the height of the convex structure is increased by 200% to 250%, so as to prevent the quality of the file sensor attached with a curve cover from being affected by the springback effect after the thermoforming process.

In order to achieve the objective, the present invention provides a method of manufacturing a thermoforming convex mold, and the method includes following steps. First, the specification of a convex fixture is provided according to a curve shape of a thermoformed film sensor, and the curve shape has a plane portion and a curve portion downwardly and vertically extended from edges of the plane portion, the convex fixture comprises a base and a convex structure extended upwardly from a top of the base, the height of each of the convex structure and the curve portion are in a range of 1 mm to 5 mm, the shape of a top of the convex structure is the same as a shape of the plane portion, an area of the top of the convex structure is less than an area of the plane portion, and a curvature radius of a curve corner between the top and a side wall of the convex structure is lower than 2 mm and higher than 0 mm. Next, the specification is adjusted by inwardly shrinking the side walls of the convex structure by 0.4 mm to 0.6 mm uniformly, and increasing the height of the convex structure by 200% to 250%. A convex mold is produced according to the adjusted specification of the convex fixture.

According to an embodiment, the curve portion is fabricated to have four surfaces vertical to each other.

According to an embodiment, the top of the convex structure is fabricated to have a rectangular shape.

According to an embodiment, a diagonal line of the rectangular shape is fabricated to have a range of 5 inches to 7 inches.

According to an embodiment, the height of the convex structure is equal to that of the curve portion.

According to an embodiment, material of the convex mold comprises bakelite, stainless steel or graphite.

According to an embodiment, the film sensor comprises a transparent substrate and a sensing layer thereon.

According to an embodiment, material of the transparent substrate is polyethylene terephthalate (PET).

According to an embodiment, a Young's modulus of the transparent substrate is in a range of 1.5×10⁹ Pa to 3×10⁹ Pa.

According to an embodiment, the sensing layer further comprises a plurality of transparent electrode serials.

### BRIEF DESCRIPTION OF THE DRAWINGS

The structure, operating principle and effects of the present invention will be described in detail by way of various embodiments which are illustrated in the accompanying drawings.

FIGS. 1(A) and 1(B) are sectional structural views showing convex fixtures in different steps of an embodiment of a method of manufacturing a thermoforming convex mold, according to the present invention.

FIG. 2 is a perspective view of a structure of a convex mold of the present invention.

FIG. 3 is a flowchart showing the steps in an operation of an embodiment of a method of manufacturing thermoforming convex mold of the present invention.

FIG. 4 is a curve diagram of the heightening rate of a convex fixture and the amount of springback of a film sensor, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

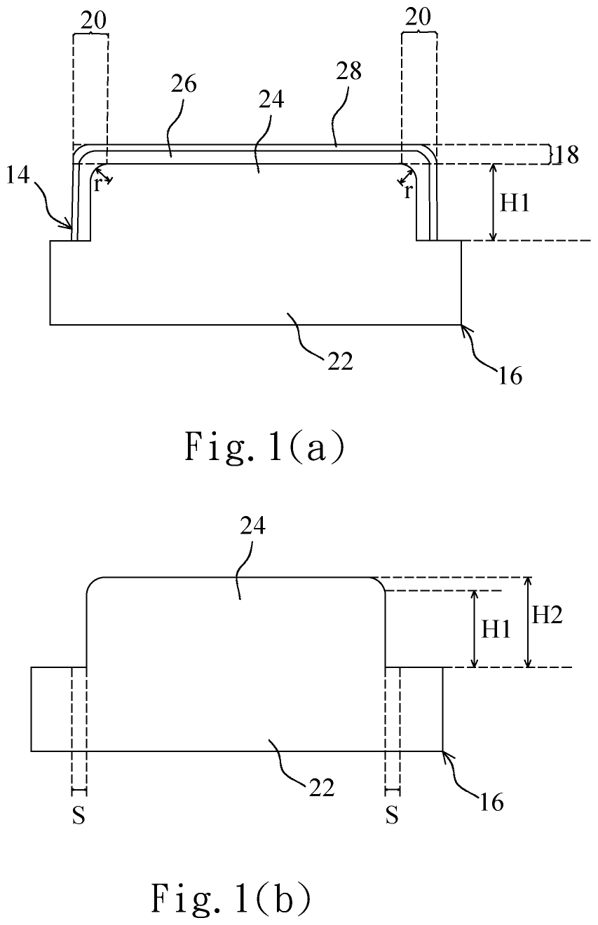

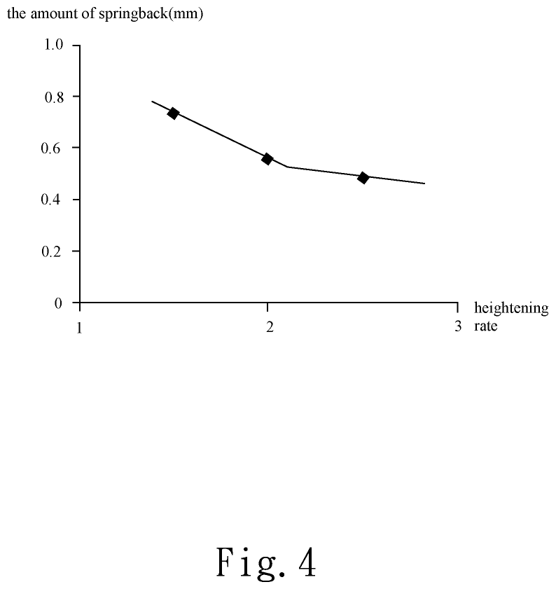

Please refer to FIGS. 1(A), 1(B), 2, 3 and 4, which describe the operations of the method of manufacturing a thermoforming convex mold of the present invention. As shown in FIG. 1(A) and step S10, the specification of a convex fixture 16 is provided according to the curve shape of a thermoformed film sensor 14. The curve shape has a plane portion 18, and a curve portion 20 downwardly and vertically extended from edges of the plane portion 18. The curve portion 20 is fabricated to have four surfaces vertical to each other. The convex fixture 16 has a base 22 and a convex structure 24 upwardly extended from a top of the base 22. The height of each of the convex structure 24 and the curve portion 20 is in a range of 1 mm to 5 mm, and the height H1 of the convex structure 24 is equal to the height of the curve portion 20. The height H1 of the convex structure 24 is a distance from a top of the convex structure 24 to the top of the base 22, and the curve portion 20 is defined by the height H1, so that the height of the curve portion 20 is equal to the height H1. The shape of the top of the convex structure 24 is the same as a shape of the plane portion 18, for example, the top of the convex structure 24 may be made in a rectangular shape, and the diagonal line of the rectangular shape is fabricated to have a range of 5 inches to 7 inches. The area of the top of the convex structure 24 is less than the area of the plane portion 18, the curvature radius r of a curve corner between the top and the side wall of the convex structure 24 can be lower than 2 mm and higher than 0 mm.

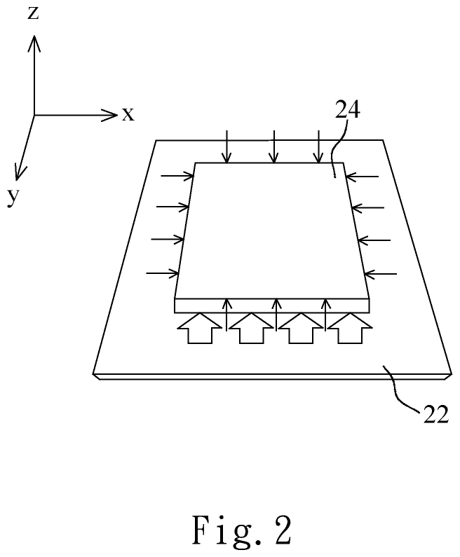

As shown in FIG. 1(B), FIG. 2 and step S12, the specification can be adjusted by inwardly shrinking the side walls of the convex structure 24 uniformly by 0.4 mm to 0.6 mm, and increasing the height of the convex structure 24 by 200% to 250%. Next, the convex mold is produced according to the adjusted specification of the convex fixture 16. As shown in the convex mold of FIG. 1(B), the distance S is in a range of 0.4 mm to 0.6 mm, the height H2 of the convex mold is 200 percent to 250 percent of the height H1; in other words, the convex structure 24 is shrunk in x and y directions, and heightened in a z direction. As a result, the convex fixture 16 of the present invention has a decreased width and increased height, and the specification is adjusted according to a heightening ratio and a shrinkage ratio, during the manufacturing process of the convex fixture 16. The convex fixture 16 can be directly turned and milled by the conventional mechanical manufacturing process. The main concept of the present invention is to determine a ratio, according to expansion and contraction property of the film sensor 14, for designing the thermoformed convex fixture 16 of the film sensor 14. The conventional method of designing the fixture is to directly manufacture the fixture according to a predetermined shape, and then adjust the manufactured fixture according to experience when the manufactured fixture does not meet the requirement; however, it takes a longer time and reduces yield rate of manufacturing process.

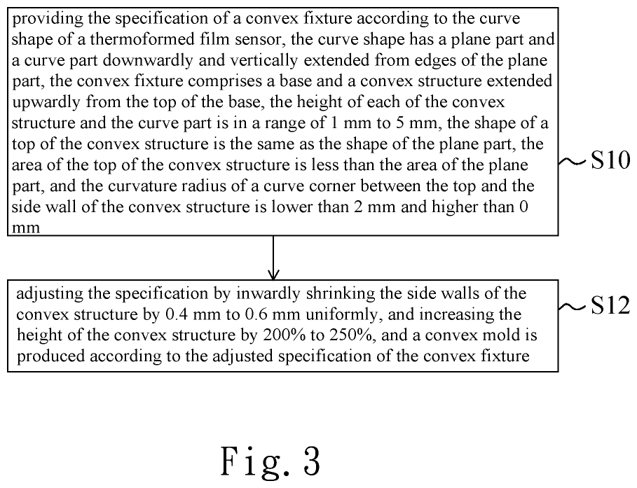

The convex mold 24 can be made by material, which has heat resistance to 150° C. and can withstand a tension of the film sensor 14; for example, the material of the convex mold 24 comprises bakelite, stainless steel or graphite. The film sensor 14 can comprise a transparent substrate 26 and a sensing layer 28 disposed on the transparent substrate 26. In an embodiment, the sensing layer 28 can include a plurality of transparent electrode serials, and each transparent substrate 26 has a low dielectric constant and high transmittance, for example, the transmittance of the transparent substrate 26 can be in a range of 87% to 95%. In an embodiment, the Young's modulus of the transparent substrate 26 can be in a range of 1.5×10⁹ Pa to 3×10⁹ Pa. For example, the material of the transparent substrate 26 can be polyethylene terephthalate (PET). The adjustment of the specification of the convex fixture 16 must match the material of the transparent substrate 26, the height H1 of the convex structure 24, the area of the top of the convex structure 24, and the curvature radiuses r of the curve corners between the top and the side walls of the convex structure 24. In FIG. 3, the Young's modulus of the transparent substrate 26 is 1.5×10⁹ Pa, the height H1 of the convex structure 24 is 3.2 mm, the diagonal line of the rectangular area of the top of the convex structure 24 is 5 inches, and the curvature radius r of the curve corner between the top and the side wall of the convex structure 24 is lower than 2 mm and higher than 0 mm. When the height of the convex structure 24 is increased by 50%, the amount of springback of the film sensor 14 is 0.74 mm; when the height of the convex structure 24 is increased by 200%, the amount of springback of the film sensor 14 is 0.56 mm; when the height of the convex structure 24 is increased by 250%, the amount of springback of the film sensor 14 is 0.49 mm. In other words, when the height of the convex structure 24 is increased by 200% to 250%, the amount of springback of the film sensor 14 is in a range of 0.4 mm to 0.6 mm. For this reason, in an embodiment, the side walls of the convex structure 24 of the present invention can be uniformly shrunk inwardly by 0.4 mm to 0.6 mm, and the height of the convex structure 24 can be increased by 200% to 250%, so as to prevent the attachment quality of the film sensor 14 and the curve cover from being affected by the springback effect of the film sensor 14 after the thermoforming process.

In conclusion, the specification of the convex fixture of the present invention is provided according to the required shape of the film sensor, and the side walls of the convex structure of the convex fixture are then uniformly shrunk inwardly by 0.4 mm to 0.6 mm, and the height of the convex structure is increased by 200% to 250%, so as to prevent the laminated quality of the film sensor 14 and the curve cover from being affected by the springback effect of film sensor 14 after the thermoforming process.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of manufacturing a thermoforming convex mold, comprising:
providing a specification of a convex fixture according to a curve shape of a thermoformed film sensor, the curve shape has a plane portion and a curve portion downwardly and vertically extended from edges of the plane portion, the convex fixture comprises a base and a convex structure extended upwardly from a top of the base, a height of each of the convex structure and the curve portion is in a range of 1 mm to 5 mm, a shape of a top of the convex structure is the same as a shape of the plane portion, an area of the top of the convex structure is less than an area of the plane portion, and a curvature radius of a curve corner between the top and a side wall of the convex structure is lower than 2 mm and higher than 0 mm; and
inwardly shrinking the side walls of the convex structure by 0.4 mm to 0.6 mm uniformly, increasing the height of the convex structure by 200% to 250%, so as to adjust the specification, and producing a convex mold according to the adjusted specification of the convex fixture.

2. The method according to claim 1, wherein the curve portion is fabricated to have four surfaces vertical to each other.

3. The method according to claim 1, wherein the top of the convex structure is fabricated to have a rectangular shape.

4. The method according to claim 3, wherein a diagonal line of the rectangular shape is fabricated to have a range of 5 inches to 7 inches.

5. The method according to claim 1, wherein the height of the convex structure is equal to that of the curve portion.

6. The method according to claim 1, wherein material of the convex mold comprises bakelite, stainless steel or graphite.

7. The method according to claim 1, wherein the film sensor comprises a transparent substrate and a sensing layer thereon.

8. The method according to claim 7, wherein material of the transparent substrate is polyethylene terephthalate (PET).

9. The method according to claim 7, wherein a Young's modulus of the transparent substrate is in a range of 1.5×10⁹ Pa to 3×10⁹ Pa.

10. The method according to claim 7, wherein the sensing layer further comprises a plurality of transparent electrode serials.
